(19) United States
(12) Patent Application Publication
(10) Pub. No.: US 2004/0031366 A1
(43) Pub. Date: Feb. 19, 2004

(54) Compound venetian blind cutting and trimming machine

(76) Inventor: Shien-Te Huang, Taipei (TW)

Correspondence Address: Shien-Te Huang, P.O. Box No. 6-57, Chung-Ho, Taipei, 235, TW

(21) Appl. No.: 10/219,333

(22) Filed: Aug. 16, 2002

(51) Int. Cl. B26D 7/02; B23D 7/00; B27B 19/00

(52) U.S. Cl. 83/454; 83/465; 83/746

(57) ABSTRACT

A compound Venetian blind cutting and trimming machine, more specifically, a cutting machine capable of synchronously cutting and trimming a Venetian blind of wooden and metallic materials, mainly comprises a base plate with a through slot disposed on the front plane of the said base plate and provided for every material to extend through; a filing blade moving transversely is disposed on one lateral side of a material feeding blade; the upper rim of the said base plate is provided for the sliding of a replaceable hand-held electric saw; the existence of the two cutting tools of the said electric saw and the filing blade cuts and trims the metallic or wooden materials of a venetian blind at the same time.

### BACKGROUND OF THE INVENTION

1) Field of the Invention

A compound venetian blind cutting and trimming machine, more specifically, a cutting machine capable of synchronously cutting and trimming a venetian blind composed by both wooden and metallic materials.

2) Description of the Prior Art

Accordingly, a general venetian blind can be made of not only the traditional wooden material, but also the aluminum or plastic materials; various materials are composed for different selections according to the usage conditions; the said blind is referred to a transverse and venetian blind, more specifically the blind which has the upper rail portion formed of a C-shape and made of metallic material due to the issue of the mechanic strength; since the strips of the blind and the lower rod portion are usually for the shading effect, the strength thereof is not required to be very strong, therefore, the wooden or aluminum materials can be adopted for these portions; in addition, for obtaining a pleasant appearance and the esthetic effect of being natural and pristine, the wooden material is adopted most often for the said lower rail portion while the metallic material is reserved for the upper rail portion for the issue of strength; the length of the blind needs to be cut correspondingly to the widths and the shading areas of different windows; in order to smoothly and synchronously cut and trim both the metallic and the wooden materials, the cutting machine of the prior art uses an electric saw with round-shaped saw blade; however, the said round-shaped saw blade not only generates noises during cutting procedure, but also may cause extreme danger in operation, therefore, it is not used for cutting recently; furthermore, only a seasoned technician knows how to control that kind of cutting operation; it has the drawback of being inconvenient in basic application.

### SUMMARY OF THE INVENTION

Therefore, the primary objective of the present invention is to specifically provide a saw plate linked by a filing blade and an electric saw; both of them can synchronously cut and trim the metallic and wooden materials; when the hand-held electric saw finishes the cutting movement, it touches the filing blade to be driven electrically by a motor; the movement of the said motor resumes automatically to the original position by means of apparatuses such as a return switch for further obtaining a semi-automatic cutting and trimming operation for a compound venetian blind, or obtaining separate and manual operations for different application conditions.

Another objective of the present invention is to provide the maintenance facilitation in application by having a sliding plate to lock joint the said handheld electric saw and the base plate for free dismounting and replacement; the said hand-held electric saw can be directly replaced by an electric saw available on the market.

Yet another objective of the present invention is to dispose a flexible locating apparatus on the front plane of the said base plate; the said locating apparatus mainly has a locating scale with a resilient plate; at the beginning of locating, the locating scale of the resilient plate efficiently provides a cutting end for every venetian blind material; the top side of the cutting end aligns flush with the graduation for cutting and effectively corresponds to the graduated scale; when the fining blade is cutting, the waste material cut off by the filing blade is pushed out; the length pushed out can be absorbed by the resilient plate to facilitate the position of the locating scale not to be changed by the waste material when the blade is feeding.

To enable a further understanding of the present invention, the brief description of the drawings below is followed by the detailed description of the preferred embodiment.

### BRIEF DESCRIPTION OF THE DRAWINGS

FIG. 1 is a pictorial drawing of the assembled present invention.

FIG. 2 is a structural drawing of a filing blade linked by a motor of the present invention.

FIG. 3 is a drawing of the implementary status of the present invention.

FIG. 4 is a schematic and bird's-eye drawing of the cutting implementation of the present invention.

### DETAILED DESCRIPTION OF THE PREFERRED EMBODIMENTS

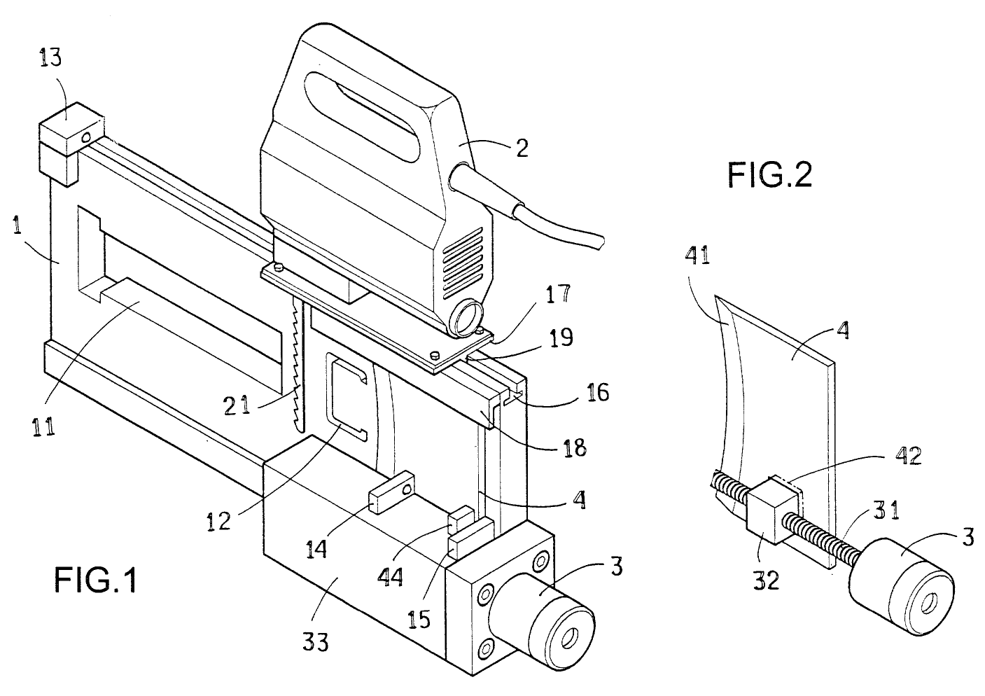

Referring to FIG. 1, the present invention mainly has a base plate (1) with through slots (11) disposed for the strips and a lower rail to extend through as well as a through slot (12) for a upper rail to extend through; a T-inverted sliding channel (16) is disposed longitudinally on the upper rim of the said base plate (1); the said sliding channel (16) is provided for a sliding key (19) underneath a sliding plate (17) to slide in; a hand-held electric saw (2) is lock jointed upward on the said sliding plate (17); a touch switch (13) is disposed at the cutting terminal end of the said base plate (1); a return switch (14) and a stop switch (15) are disposed on the front plane thereof; a limiting seat (33) is disposed between the said base plate (1) and the motor (3); the said limiting seat (33) is provided for assembling the motor (3) to link a filing blade (4); the upper rim of the said filing blade (4) is held by a upper plate (18) to retain to the upper rim of the said base plate (1); therefore, the body of the said blade (4) flatly attaches the front plane of the said base plate (1); relatively to the cutting for the said upper rail through slot (12), a saw plate (21) is disposed downwardly on the said electric saw (2) relative to the through slot (11).

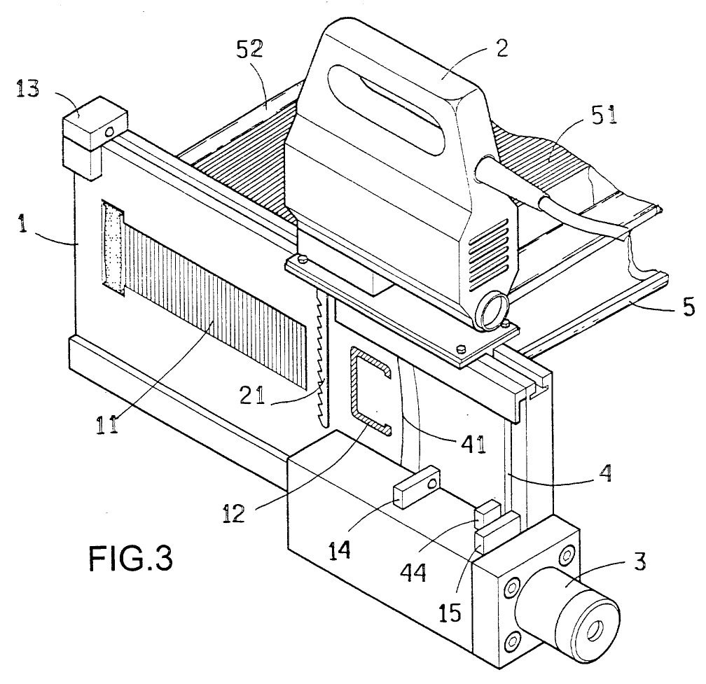

Referring to FIG. 2, the function of the motor (3) linking the filing blade (4) is that a threaded rod (31) axially disposed at the output end of the said motor (3); the said threaded rod (31) rotates a link tenon (32); the said link tenon (32) can be formed of a square plug with one end inserted into the inside of an insert hole (42) disposed on the filing blade (4); therefore, by the manner of retaining, the function of the forward and backward rotation of the motor (3) links the filing blade (4) to displace by moving forward and retracting backward.

Referring to FIG. 3, when the metallic upper material (5) extends through the said upper rail slot (12) as well as the strips (5 1) and the lower rod (52) extend through the through slot (11) disposed oppositely on the base plate (1), the said electric saw (2) is pushed by manual operation; the up-and-down sawing movement of the saw blade (21) disposed thereof is utilized to saw and cut the said wooden strips (5) and the lower rod (52); as the cutting reaches the terminal end, the forward position of the electric saw (2) touches the said touch switch (13); the touch switch (13) sends out a command for the motor (3) to drive the filing blade (4) to move forward and cut the said upper rail (5); the said filing blade (4) links a retaining plate (44); after the retaining plate (44) moves forward and touches the return switch (14), the return switch (14) sends out a command to make the motor (3) rotate reversely and retract the filing blade (4); after the filing blade (4) retracts, the said retaining plate (44) touches the stop switch (15) in the other direction; the said stop switch (15) makes the motor (3) stop moving. The above-mentioned mechanical and electrical control is of a common circuit structure and won't be described here. Through the mentioned structural method, after the electric saw (2) is manually operated to cut and touches the touch switch (13) to send out a command so as to make the motor (3) drive the filing blade (4) to cut the upper rail (5), the metallic and the wooden materials can be cut separately and synchronously in a cutting operation; furthermore, since the said filing blade (4) is linked by the motor (3) to form an electrically mechanical operation, the motor (3) can be adapted by using a rocking lever to rock the filing blade (4); that barehanded operation can utilize a traditionally mechanical operation to drive the filing blade (4) and that won't be described here.

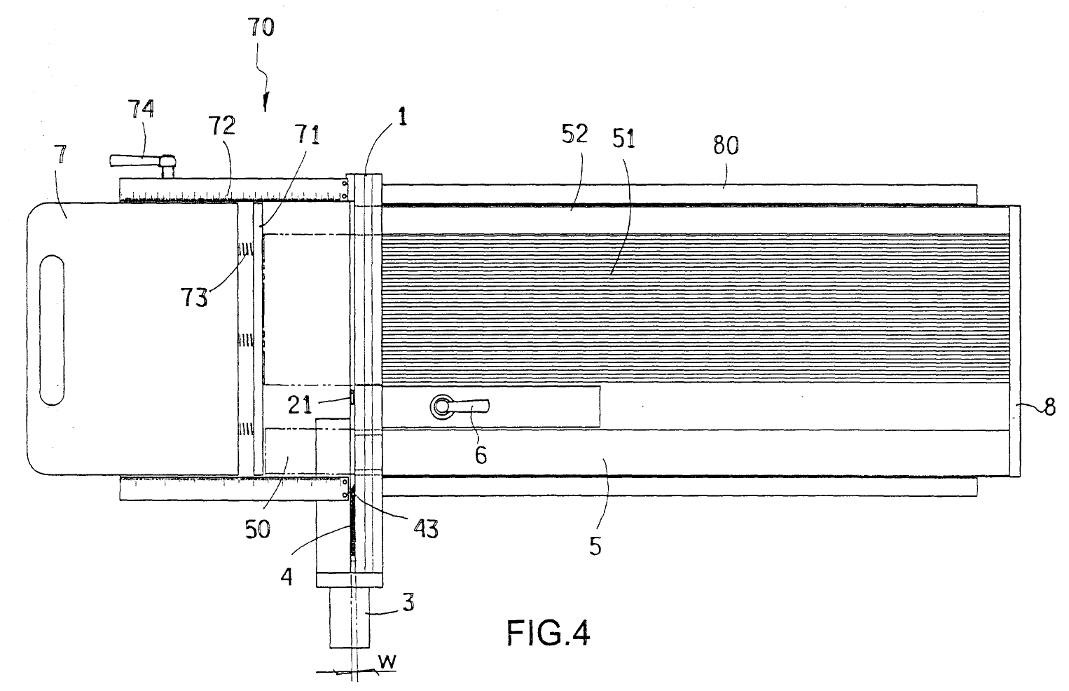

Referring to FIG. 4, the material feed end of the base plate (1) is disposed with a sliding platform (80); the said sliding platform (80) provides a push plate (8) to slide longitudinally; the said push plate (8) is a parallel plate body and simultaneously pushes the upper rail material (5), the strips (51) and the lower rod (52) to make the cutting end thereof, after passing the through holes (11, 12), correspond to a resilient plate (71) of a locating scale (7) disposed on a locating apparatus (70); generally, after the resilient plate (71) aligns with the scale (72), a stop rod (74) locks the said locating scale (7) in place for the next measuring and locating; a resilient spring (73) is moveably fastened to connect the said resilient plate (71) and the locating scale (7); after every material extends through every material plate during cutting, the resilient function of the said resilient plate (71) provides a continuous and sequential cutting for the wooden material to be sawn by the saw blade (21) and for the upper metallic material (5) to be cut by the blade edge of the filing blade (4); the blade edge disposed on the filing blade (4) has a beveled side (43); therefore, after being driven by the motor (3), the said filing blade (4) pushes forward following the cutting line; since the filing blade has a thickness (W), as the said thickness (W) squeezes into the cutting line of the upper rail material (5), the other waste material end (50) deforms or extends toward the left side after being squeezed and definitely forms a pushing force toward the locating scale (7); the locating scale (7) is fixed at the position of the scale (72) by means of the stop rod (74), when the waste end (50) pushes toward the left side, the resilient flexibility of the resilient plate (71) absorbs the displacement force to assure the selected position of the locating scale (7) not to be changed thereby to facilitate the preparation for the next measurement; for the traditional ones, the said locating scale (7) is fixedly locked by the stop rod (74), after all the materials are pushed in, a locating rod is released to allow the locating scale (7) to slide and retract freely as all the materials are pushed out; during the next cutting, similarly, the locating scale (7) has to return to the original position and be locked by the stop rod (74) again; after all the materials are aligned, the locating rod is again pulled to release to allow the locating scale (7) to freely move again, so the traditional ones are very inconvenient in application; therefore, the present invention particularly utilizes a resilient plate (71) to absorb the displacement changing force of the said projecting waste material end (50) to assure the locating scale (7) to be able to permanently and efficiently situate at the selected position.

The sliding platform (80) disposed in the present invention is provided for all the materials to be efficiently loaded and slide on the sliding platform (80); the push plate (8) pushes all the materials to be positioned by the locating scale (7) and fixedly locked by the left-and-right extension method of a lock rod (6); the lock rod (6) is in a form of a handle bar and links a tension element therein after being turned so as to press laterally and respectively against the upper rail material (5), the lower rod (52) and the strips (51) to eliminate the vibrating wave caused by the working motor (3) to make possible displacement; the locking and tension method of the said lock rod (6) can be achieved by any traditional mechanical structure and that won't be described here.

Another objective of the present invention is to use a screw to fixedly lock and connect the electric saw (2), as shown in FIG. 3, and the table plate (23); therefore, the maintenance or the replacement of the electric saw (2) is operated very conveniently.

1. A compound venetian blind cutting and trimming machine, more specifically, a cutting machine provided for Venetian blind composed of wooden material and metallic material, mainly has a base plate; the front plane of the inside of the base plate is disposed with a through hole for the upper rail material to extend through and through holes for the strips and the lower rod to extend through; the features of the cutting machine is that the front plane of the machine is disposed with a limiting seat; the inside of the limiting seat corresponds to a filing blade; the said filing blade works at the position of the upper rail through slot; a hand-held electric saw is slidably disposed on the upper rim of the base plate; a saw plate is disposed downwardly on the said electric saw; the saw plate corresponds to through holes of the strips and the lower rail and that is the main feature thereof.

2. A compound venetian blind cutting and trimming machine according to claim 1, wherein, the upper rim of the base plate is disposed with a sliding channel provided for the slide of a sliding plate used for loading the electric saw.

3. A compound venetian blind cutting and trimming machine according to claim 1, wherein, on the upper rim of the base plate, corresponding to the cutting terminal end of the electric saw, a touch switch is disposed for sending a command for the motor to drive.

4. A compound venetian blind cutting and trimming machine according to claim 1, wherein, the retaining plate position on the filing blade is disposed correspondingly with a return switch and a stop switch.

5. A compound venetian blind cutting and trimming machine according to claim 1, wherein, a locating apparatus is disposed at the front plane position of the said base plate; a resilient plate is forwardly disposed at the locating scale mounted on the locating apparatus.
